(19) United States
(12) Patent Application Publication
(10) Pub. No.: US 2002/0100901 A1
(43) Pub. Date: Aug. 1, 2002

(54) Vehicle lifting system

(76) Inventors: Zac Topelberg, Kfar Ben Nun (IL); Michael Ziv, Hertselia (IL)

Correspondence Address: BROWDY AND NEIMARK, P. L. L. C., 624 Ninth Street, N. W., Washington, DC, 20001, US

(21) Appl. No.: 09/770,222

(22) Filed: Jan. 29, 2001

(30) Foreign Application Priority Data
Jan. 26, 2001 (IL) 141125

(51) Int. Cl. B60S 9/02

(52) U.S. Cl. 254/423

(57) ABSTRACT

A lifting system for raising a vehicle having a plurality of wheels. The system comprises: (a) one or more jacks capable of being extended and retracted, each jack being attached to the underside of the vehicle proximate to one of the wheels; and (b) a control device capable of independently controlling the extension and retraction of each of the jacks. Also disclosed is a method for lifting a vehicle.

### FIELD OF THE INVENTION

This invention relates to a system and method for lifting vehicles.

### BACKGROUND OF THE INVENTION

There are numerous occasions on which it becomes necessary to lift at least a portion of a motor vehicle off the ground. The most common one is the replacement of a tire. Other occasions include situations during off-road driving such as deep mud, sand, crevices, crossed wheels, etc. when it is necessary to extract the vehicle from an entanglement.

In all of these situations, the driver must exit from the vehicle and operate an external device, usually a jack, to lift the vehicle. This can create a problem for people, such as disabled persons, who have difficulty in operating such a device. Furthermore, the operation of the jack increases the amount of time necessary to be outside the vehicle, this being discomforting in cases of adverse weather conditions. In addition, improper operation of the jack can be dangerous to the operator and lead to injury.

### SUMMARY OF THE INVENTION

It is an object of the invention to provide a system for lifting a vehicle.

It is a further object of the invention to provide a method for lifting a vehicle.

Thus, in one aspect the present invention provides a lifting system for raising a vehicle having a plurality of wheels. The system comprises (a) one or more jacks capable of being extended and retracted, each jack being attached to the underside of the vehicle proximate to one of said wheels; and (b) a control device capable of independently controlling the extension and retraction of each of the jacks.

The system of the present invention allows one to lift the vehicle without emerging from it. The system is suitable for all types of vehicles including, but not limited to, family automobiles, 4-wheel drive vehicles and trucks.

The term “jack” in the present invention denotes a lifting device used to raise a portion of a vehicle. The specifications of the jack will take into account the vehicle weight and other relevant data regarding the specific vehicle. A mechanical jack may operate by a system of ratchets, gears, and/or screws. In a preferred embodiment, the jack is a hydraulic jack which makes use of pistons and fluids. The jack is attached to the underside of the vehicle, preferably to the chassis, at a location proximate to the vehicle wheel. For example, the jack may be attached at the location on the chassis provided by the vehicle manufacturer for placing a conventional jack when lifting the vehicle. The jack may be attached to the vehicle by conventional means such as bolts, soldering, etc. Preferably, each wheel has a jack located near it.

Actuation of the jack causes it to become extended, thereby lifting the vehicle. In its inactive state, the jack is in a retracted position. Preferably, the jack in its retracted position does not protrude from the underside of the vehicle so as not to interfere with the motion of the vehicle.

The jack may be actuated by conventional means such as mechanical, hydraulic, etc. An example of a by hydraulically-driven system is given below.

The control device of the system of the invention may be any means capable of actuating the jack. For example, if the jack is mechanically driven by an electric motor, the control device would activate the motor. If the jack is operated by hydraulic means, the control device could open and close a valve allowing fluid to flow to or from the jack, operate a fluid pump, etc. The control device may directly actuate the jack, e.g. through electric wires connected to a motor or valve, or it may operate as a remote control device, e.g. by sending out radio signals, etc., as is known in the art.

The control device comprises a control panel having means to actuate each of the jacks. The control panel may be installed in the passenger compartment of the vehicle. e.g. near the driver, so that the driver may operate the jacks without the necessity of emerging from the vehicle. In the case of a remote control device, the control panel may be a wireless control module. The system may be configured for safety reasons so that only one of the jacks may be operated at one time, or only when the vehicle is immobile. For example, the system can be controlled by a micro-switch connected to the braking pedal, so that the system is enabled only when the pedal is pressed.

In a second aspect of the invention, there is provided method for lifting a vehicle having a plurality of wheels. The vehicle comprises (a) one or more jacks capable of being extended and retracted, each jack being attached to the underside of the vehicle proximate to one of said wheels; and (b) a control device capable of independently controlling the extension and retraction of each of said jacks. The method comprises activating said control device thereby extending one or more of said jacks.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a side perspective view of a vehicle in which one of the jacks according to one embodiment of the invention is extended, thereby lifting the vehicle;

FIGS. 2 & 3 are perspective views from below the vehicle; and

FIG. 4 is a schematic view of a control panel according to one embodiment of the invention.

### DETAILED DESCRIPTION OF A PREFERRED EMBODIMENT

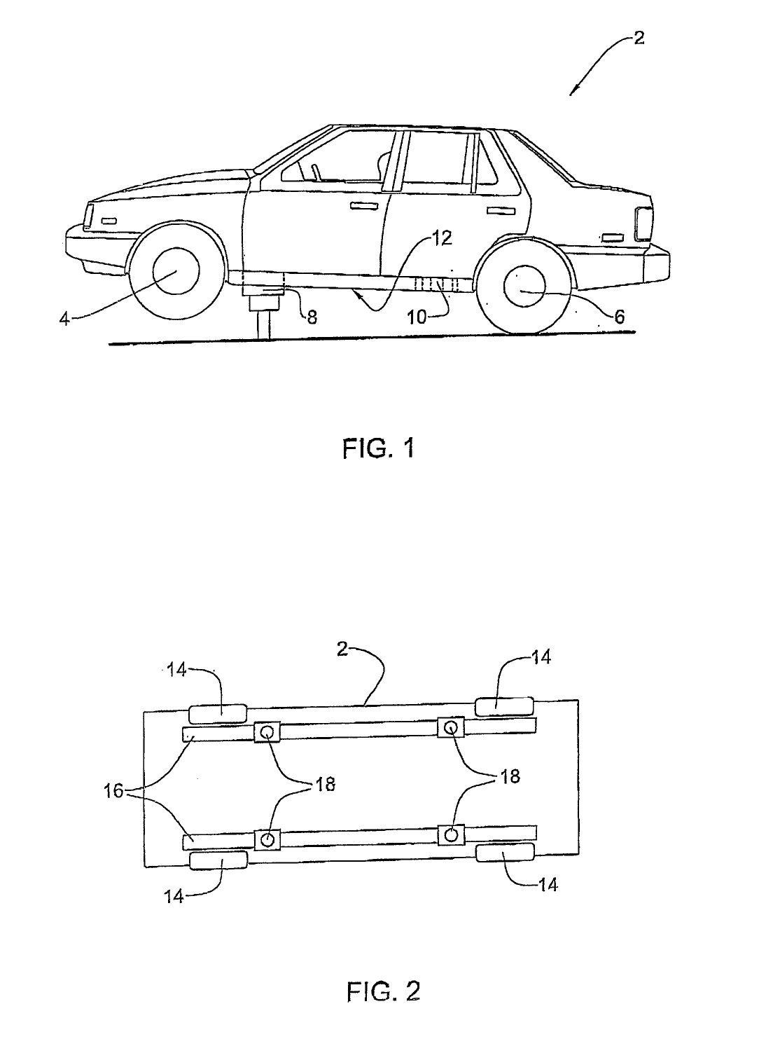

FIG. 1 illustrates a vehicle 2 comprising a system according to one embodiment of the invention. The vehicle 2 comprises four wheels, a front 4 and a rear 6 wheel of which may be seen in the figure. Proximate to the wheels 4 & 6 are a front 8 and a rear 10 jack, respectively, attached to the underside 12 of the vehicle. The front jack 8 is in an extended position while the rear jack 10 is in a retracted position and does not protrude from the underside 12 of the vehicle.

In FIG. 2, the underside of the vehicle 2 may be seen with its four wheels 14 and the bottom of the vehicle chassis 16. Each jack 18 is mounted on the chassis 16 proximate to one of the wheels 14. The jacks may be actuated by an oil-based hydraulic system illustrated in FIG. 3. The hydraulic system comprising an oil tank and pump 20, tubing 22 connecting between the pump 20 and the jacks 18, and valves 24 connected to the tubing.

The oil tank and pump 20 may be located anywhere in the vehicle and will generally have a shape that will not interfere with the vehicle's normal operation. They may be installed in the vehicle, e.g. by screws, and may have a proper housing with preparation for the installment. The pump will preferably have the ability to pump the fluid in two opposite directions, i.e. to extend the hydraulic jack and return the oil back to the tank.

Valves 24 may be attached to the pump 20 either directly or by intermediate short flexible tubing 26, and each valve is in fluid communication through tubing 22 with one of the jacks 18. The valves may be opened/closed by receiving a command from the control device. For example, if the valves are electrically operated, an electrical command sent by the control device either by wire or by remote signal will cause the valve to open resulting in the extension of the jack. The command may operate the pump and the designated valve at the same time.

The hydraulic jack 18 when in a retracted position, will contain no oil and may have a safety pin to prevent it from extending if it is self-released. The jack may be composed from a serious of coaxial tubes so that when retracted, the jack will not protrude below the vehicle axle or the exhaust system. The jack may have a flat base with holes for screws for attachment to the chassis, or any other known means of attachment.

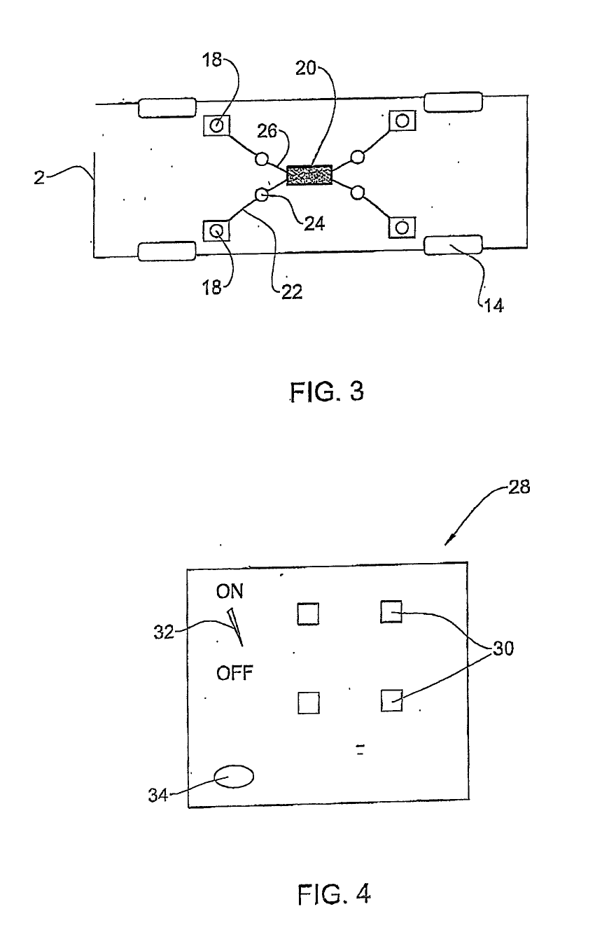

FIG. 4 illustrates one embodiment of the control panel 28, which may be placed in the vehicle passenger compartment. The panel comprises four buttons 30 that can be pushed to operate each of the jacks. It may also have an on-off switch 32, and a warning light 34 to indicate when the system is operational. For safety purposes, a micro switch may be installed on the braking pedal, or a wire may be connected to the braking lights, so that only when the brake is pressed will the command panel be activated.

1. A lifting system for raising a vehicle having a plurality of wheels comprising:
(a) one or more jacks capable of being extended and retracted, each jack being attached to the underside of the vehicle proximate to one of said wheels; and
(b) a control device capable of independently controlling the extension and retraction of each of said jacks.

2. A system according to claim 1 comprising one jack for each of said wheels.

3. A system according to claim 1 further comprising a hydraulic system connected to said jacks.

4. A system according to claim 3 wherein said hydraulic system is oil-based.

5. A system according to claim 4 wherein said hydraulic system comprises an oil tank and an oil pump to pump the oil between the tank and the jacks.

6. A system according to claim 3 wherein said hydraulic system comprises a valve in fluid communication with each of said jacks.

7. A system according to claim 6 wherein said valves are actuated by said control device.

8. A system according to claim 1 wherein said jacks are mechanically operable.

9. A system according to claims 1 wherein said control device directly controls the operation of said jacks.

10. A system according to claim 9 wherein said control device is located within a passenger compartment of said vehicle.

11. A system according to claims 1 wherein said control device remotely controls the operation of said jacks.

12. A system according to claim 1 wherein said jacks can be extended only when said vehicle is immobile.

13. A system according to claim 1 wherein only one of said jacks can be extended or retracted at one time.

14. A system according to claim 1 wherein said jacks are attached to the chassis of the vehicle.

15. A system according to claim 1 wherein said jacks in their retracted state do not protrude from the underside of said vehicle.

16. A system according to claim 1 wherein said jacks are mounted on the chassis of the vehicle.

17. A method for lifting a vehicle having a plurality of wheels, wherein said vehicle comprises:
(a) one or more jacks capable of being extended and retracted, each jack being attached to the underside of the vehicle proximate to one of said wheels; and
(b) a control device capable of independently controlling the extension and retraction of each of said jacks;
said method comprising activating said control device thereby extending one or more of said jacks.
